(19) United States
(12) Patent Application Publication
(10) Pub. No.: US 2008/0247572 A1
(43) Pub. Date: Oct. 9, 2008

(54) Micro-Electro-Mechanical System (Mems) Capacitor Microphone and Method of Manufacturing Thereof

(75) Inventors: Geert Langereis, Eindhoven (NL); Johannes Wilhelmus Weekamp, Beek En Donk (NL); Jacobus Bernardus Giesbers, Son (NL)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/065,933

(22) PCT Filed: Aug. 24, 2006
(86) PCT No.: PCT/IB2006/052947

§ 371 Date: Mar. 6, 2008

(30) Foreign Application Priority Data
Sep. 9, 2005 (EP) 05108276.6
Sep. 9, 2005 (EP) 05108280.8
Apr. 21, 2006 (EP) 06112903.7
Aug. 24, 2006 (IB) PCT/IB2006/052947

(51) Int. Cl. H04R 25/00

(52) U.S. Cl. 381/174

(57) ABSTRACT

The invention relates to a method of manufacturing a MEMS capacitor microphone and further to such MEMS capacitor microphone. With the method a MEMS capacitor microphone can be manufactured by stacking pre-processed foils (10) having a conductive layer (11a,11b) on at least one side. After stacking, the foils (10) are sealed, using pressure and heat. Finally the MEMS capacitor microphones are separated from the stack (S). The pre-processing of the foils (preferably done by means of a laser beam) comprises a selection of the following steps: (A) leaving the foil intact, (B) locally removing the conductive layer, (C) removing the conductive layer and partially evaporating the foil (10), and (D) removing both the conductive layer as well as foil (10), thus making holes in the foil (10). In combination with said stacking, it is possible to create cavities and membranes. This opens up the possibility of manufacturing MEMS capacitor microphone.

A method of manufacturing a MEMS capacitor microphone, such a MEMS capacitor microphone, a stack of foils comprising such a MEMS capacitor microphone, an electronic device comprising such a MEMS capacitor microphone and use of the electronic device.

The invention relates to a method of manufacturing a MEMS capacitor microphone provided with a space. The invention further relates to such a MEMS capacitor microphone. The invention also relates to a stack of foils comprising such a MEMS capacitor microphone according to the invention. The invention also relates to an electronic device comprising a MEMS capacitor microphone according to the invention. The invention also relates to the use of such an electronic device.

U.S. Pat. No. 5,490,220 discloses a solid state condenser and microphone device and a method to manufacture such a device. The method comprises several deposition and patterning steps in order to process functional conductive and isolating layers on a planarized silicon wafer. In addition backside etching of the silicon wafer is needed in order to release the diaphragm of the condenser or microphone device, which comprises one electrode of the condenser or microphone device. Finally the diaphragm has to be combined with a patterned backplate comprising the second electrode of the condenser or microphone device. The patterned backplate is either be formed by means of a second wafer bonded to the wafer comprising the diaphragm or being integrated in the processing of the diaphragm by means of a sacrificial layer between the diaphragm and the backplate. The sacrificial layer is etched away during backside etching as described above.

The silicon processing of the solid state condenser and microphone device is complex and expensive.

It is an objective of the invention to provide a method for manufacturing MEMS capacitor microphones avoiding the disadvantages of silicon processing.

According to the invention, this object is achieved by a method of manufacturing a MEMS capacitor microphone provided with a space, which method comprises the following steps:

providing a set of at least two electrically insulating flexible foils, wherein a conductive layer is present on at least one side of at least one foil, and wherein said conductive layer is suitable for use as an electrode or a conductor;

patterning the conductive layer so as to form an electrode or a conductor;

patterning at least one foil, in such a manner that an opening is formed, which opening forms the space of the MEMS capacitor microphone;

stacking the set of foils, thus forming the MEMS capacitor microphone; and

joining the foils together, with the foils being bonded together at those positions where, when two adjacent foils are in contact with each other, at least one conductive layer between the foil material of two adjacent foils has been removed. The use of patterned insulating flexible foils with patterned conductive layers enables a uniform manufacturing process without any semiconductor processing. The variations of processing conditions are small in comparison to semiconductor processing where the process conditions are determined by the different materials, deposition and etching methods simplifying process control. In addition no clean room facilities are needed realizing significant cost savings.

An improved embodiment of the method according to the invention is characterized in that a set of foils is provided, with the individual foils comprise the same type of foil material. A first flexible foil is considered to comprise the same type of foil material as a second flexible foil if the first flexible foil has comparable physical and chemical properties as the second flexible foil. Especially the difference between the melting point temperature in degree Celsius of the first flexible foil and the second flexible foil has to be less one third of the melting point temperature of the second flexible foil. Using the method according to the invention, a person skilled in the art will need only one kind of foil material, by means of which he will be able to form any MEMS capacitor microphone. It has furthermore become possible to obtain the foils only from one and the same roll. With the known method, on the other hand, a different material must be selected for every layer. Consequently, the method according to the invention is less complex than the known method.

An improved embodiment of the method according to the invention is characterized in that a set of foils is provided, with the individual foils having substantially the same thickness. The advantage of this aspect is that a higher degree of regularity will be obtained than with the known method. For example, if layers or spaces having a thickness different from the thickness of one foil are to be realized in a device, a multitude of foils can be stacked together in a simple manner. A foil having a different thickness is not needed, therefore. All the dimensions in the direction perpendicular to the foils will thus at all times amount to a multitude of the thickness of one foil. In addition, it will suffice to use foil from one and the same roll when using this improved method. This renders the method even less complex and consequently even more inexpensive.

An additional advantage of using foils having a uniform thickness is the fact that it is possible to implement a device in any subset of foils in a stack comprising several foils.

The method is preferably characterized in that at least three electrically insulating flexible foils are provided. This is advantageous in particular if more complex structures are to be formed, in which case two flexible foils do not suffice. Another embodiment of the method according to the invention is characterized in that at least four electrically insulating foils are provided. When at least four foils are used, more design possibilities are available to the designer.

A further embodiment of the method according to the invention comprises the additional steps of:

patterning a first flexible foil in a way that a membrane is formed covering one side of at least one opening;

patterning a second flexible foil in a way that there is at least one hole in the second flexible foil being in contact with the opening. The membrane comprises a first electrically patterned conductive layer or structured electrode being a first electrode of the MEMS capacitor microphone and the second flexible foil with holes faces the membrane and comprises a second patterned electrically conductive layer or electrode being a second electrode of the MEMS capacitor microphone. The membrane and the second flexible foil confine the at least one opening in a way that the space is formed. The holes in the second flexible foil connect the space with a further volume that a pressure balance is enabled. A movement of the membrane results into an electrical signal on an electrode an electrical signal on an electrode results into a movement of the membrane.

A further improved embodiment of the method according to the invention is characterized in that said patterning is carried out by means of a laser, whether or not in combination with a mask. This aspect makes it possible to realize a highly controlled removal of the conductive layer and/or the foil material. In addition, it is very advantageous that the space need not be cleared through selective etching of sacrificial materials, which is necessary when conventional methods are used. Using a selection from the following steps can further specify the patterning according to the invention:

leaving the conductive layer and the foil intact;

removing the conductive layer so as to expose the foil;

removing the conductive layer and part of the foil, so that a thinner foil remains; and

completely removing the conductive layer and the foil so as to form the space.

The above four basic steps provide essentially four main areas, which, when combined, can provide the desired pattern in the foils:

areas where both the foil and the conductive layer have not been removed,

areas where only the conductive layer has been removed (for example so as to form a connection with the adjacent foils),

areas where the conductive layer but also part of the foil has been removed (for example so as to manipulate the flexibility of the foil), and

areas where both the conductive layer and the foil have been removed (for example so as to create a space).

An advantageous embodiment of the method according to the invention is obtained if said stacking of the foils takes place by winding at least one foil on a first reel. A major advantage of this embodiment is that aligning the foils will be easier when the foils are being stacked.

An improved embodiment of the latter method is characterized in that the method is carried out in a process in which the foil is unwound from a second reel or roll upon being wound onto the first reel. The major advantage of this aspect is that the method can be carried out in a continuous process, so that the method will be easier to automate. Using the method the patterning of the conductive layer and the foil can take place at least at one position selected from the following possibilities: on or near the first reel, between the first and the second reel, and on or near the second reel or roll. Depending on the question whether a conductive layer is present on both sides of the foil, a person skilled in the art can choose where he wants said patterning to take place.

The method according to the invention is preferably characterized in that said joining of the foils is carried out by exerting a pressure on the stacked foils at an elevated temperature, with the pressure being exerted in a direction perpendicular to the foils. As a result, the foils will fuse together and the device will take its definitive shape.

A further elaborated embodiment of the latter method is characterized in that the required pressure on the foils adjacent to the space in the structure is obtained through the application of an elevated pressure in said space. The advantage of this aspect is that foils are pressed into better abutment with adjacent foils at places where they are adjacent to a space, so that a better adhesion of said foils will be obtained.

A further elaborated embodiment of the method according to the invention is characterized in that the MEMS capacitor microphone is individualized from the stack after fusion of the foils has taken place. The device thus obtained has this advantage that it can be traded or be incorporated in a product.

Preferred materials for the conductive layer are selected from the group consisting of aluminum, platinum, silver, gold, copper, indium tin oxide, and magnetic materials. These materials are very suitable for use as electrodes and/or conductors.

The method according to the invention is preferably characterized in that the foil material is selected from the group consisting of polyphenyl sulphide (PPS) and polyethylene terephthalate (PET). These materials are quite suitable for use as an electrically insulating foil material.

A preferred embodiment of the method is characterized in that the foil that is used has a thickness between 1 μm and 5 μm. The advantage of using a foil thickness in that range is that a reasonable degree of flexibility of the foils is obtained, as well as a reasonable degree of accuracy with which the dimensions in the device in a direction perpendicular to the foils can be fixed.

The invention further relates to a MEMS capacitor microphone (MI) comprising a stacked set (S) of at least two electrically insulating flexible foils, wherein a patterned conductive layer is present on at least one side of at least one foil, and wherein said conductive layer is suitable for use as an electrode or a conductor; at least one foil is patterned in such a manner that an opening is formed, which opening forms the space of the MEMS capacitor microphone; and the foils are bonded together at those positions where, when two adjacent foils are in contact with each other, at least one conductive layer between the foil material of two adjacent foils has been removed.

The advantage of the MEMS capacitor microphone according to the invention is that less torsional forces (for example due to temperature effects) will be generated upon stacking of the set of foils, because the layers have the same properties.

A further elaborated embodiment of this MEMS capacitor microphone is characterized in that the set of foils comprises at least three foils, with a space being present in the MEMS capacitor microphone, which space is provided on a first side thereof with a first foil arranged as a membrane for absorbing sound waves, and which space is provided on a second side thereof with a second foil arranged as a backplate, which second foil comprises an opening for the passage of pressure waves to a free space, which space has a thickness, measured in a direction perpendicular to the foils, of at least one foil, which MEMS capacitor microphone is further characterized in that the membrane and the backplate are also provided with a conductive layer, which layers lead to areas for electrically connecting the MEMS capacitor microphone. Such a design of the MEMS capacitor microphone is attractive because of its simplicity. A major advantage of this design is that the surface area of the membrane can be just as large as that of the backplate. This in contrast to a MEMS capacitor microphone in silicon technology, in which anisotropic etching of the space is required, with sloping being formed (said slope being 54.7°, for example, if said etching is carried out by means of a KOH solution in a <100> silicon wafer). Such solutions in silicon technology are known from, among other publications, the publication by Udo Klein, Matthias Müllenborn and Primin Romback, “The advent of silicon microphones in high-volume applications”, MST news 02/1, pp. 40-41.

A very attractive variant of the latter embodiment of the MEMS capacitor microphone is characterized in that the foil of the membrane or the backplate is provided with a conductive layer on two sides. The advantage of this is that the presence of a conductive layer on two sides of the foil of the membrane or the backplate prevents possible warping of the foil.

Another improvement of said MEMS capacitor microphone is obtained if the foil of the membrane comprises areas at the edges thereof which are thinner than the rest of the foil of the membrane. The advantage of this aspect is that it leads to an improved deflection profile of the membrane. Such an aspect is very difficult to realize in silicon technology, whereas it is fairly simple to realize in foil technology through partial removal of the foil (for example by means of a laser).

A preferred embodiment of the MEMS capacitor microphone according to the invention comprises an opening is formed in the stack of foils so as to provide access from one side of the MEMS capacitor microphone to a conductive layer that is connected to an electrode of the MEMS capacitor microphone. In this way a contact area is provided, as it were, for electrically connecting the electrode.

The invention also relates to a stack of foils comprising a MEMS capacitor microphone according to the invention. The stack may also be in the form of a foil that is wound on a reel.

The invention also relates to an electronic device comprising the MEMS capacitor microphone according to the invention.

The invention also relates to an electronic device comprising the stack (S) of electrically isolating foils comprising the MEMS capacitor microphone according to the invention.

One embodiment of the electronic device is characterized in that it furthermore comprises an integrated circuit for reading or driving a signal from the MEMS capacitor microphone.

A very advantageous embodiment of the electronic device according to the invention is characterized in that the MEMS capacitor microphone is provided with a recess, in which the integrated circuit is accommodated, so that the MEMS capacitor microphone in fact forms part of the package of the integrated circuit, which integrated circuit is connected to the MEMS capacitor microphone. Because of this aspect, the integrated circuit does not require a traditional package, as a result of which it is less complex and also cheaper. Moreover, the provision of an integrated circuit in this manner has an advantageous effect on the electrical operation of the MEMS capacitor microphone. The spacing between the MEMS capacitor microphone and the integrated circuit remains relatively small, so that the occurrence of capacitive and inductive interference in the connections between the MEMS capacitor microphone and the integrated circuit is reduced.

The invention also relates to the use of such an electronic device with an MEMS capacitor microphone for recording sound, wherein the MEMS capacitor microphone delivers a voltage X on electrodes and wherein the voltage X is read by the integrated circuit. The user will experience less noise when using such an electronic device.

The above and further aspects of the method and the device according to the invention will now be explained in more detail with reference to the figures, in which:

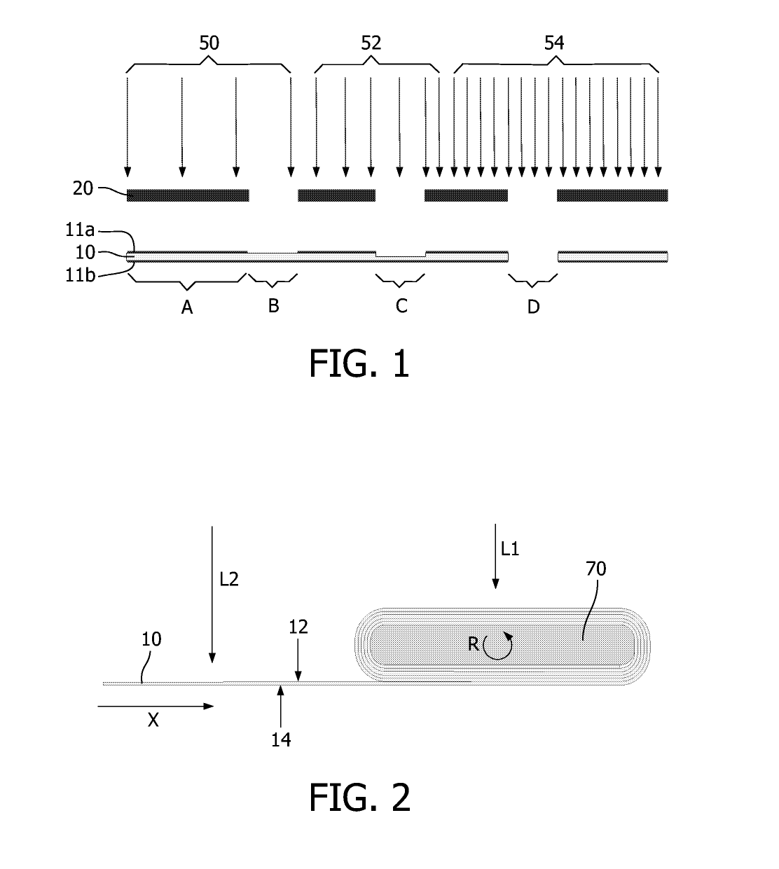

FIG. 1 is a schematic representation of a part of the method, which shows the manner in which four different areas are created on a foil with a conductive layer present thereon;

FIG. 2 shows the manner in which foils can be automatically aligned and also patterned;

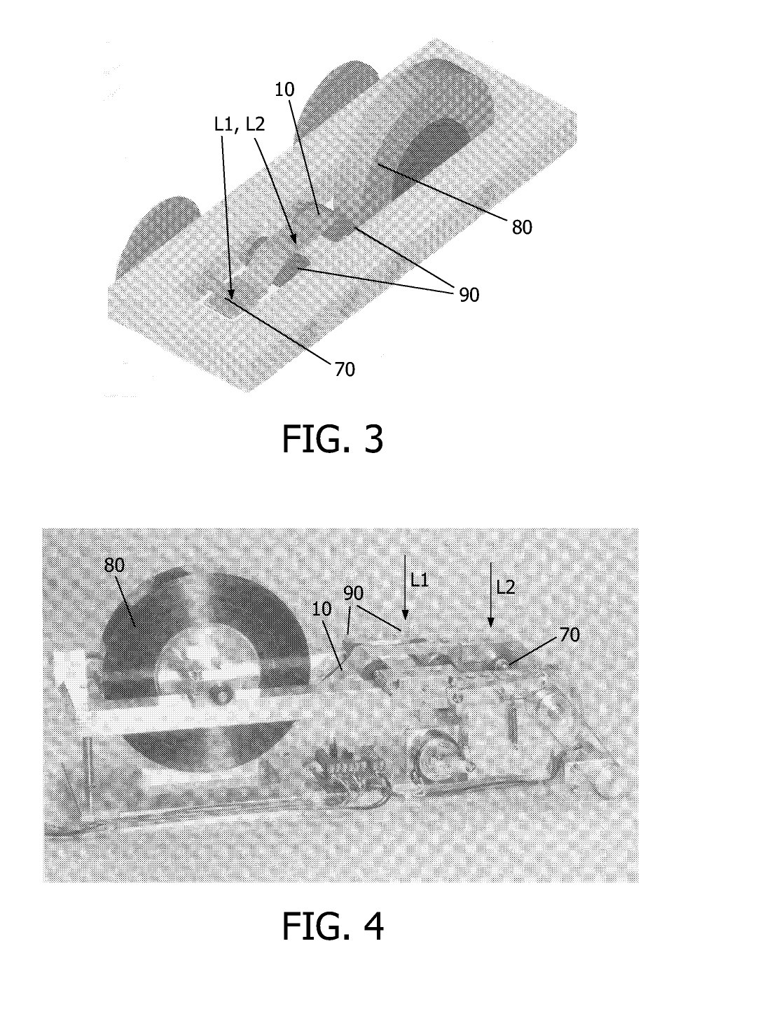

FIG. 3 is a schematic representation of an embodiment of a part of an arrangement for carrying out the method according to the invention;

FIG. 4 shows a photo of an actual arrangement for carrying out the method;

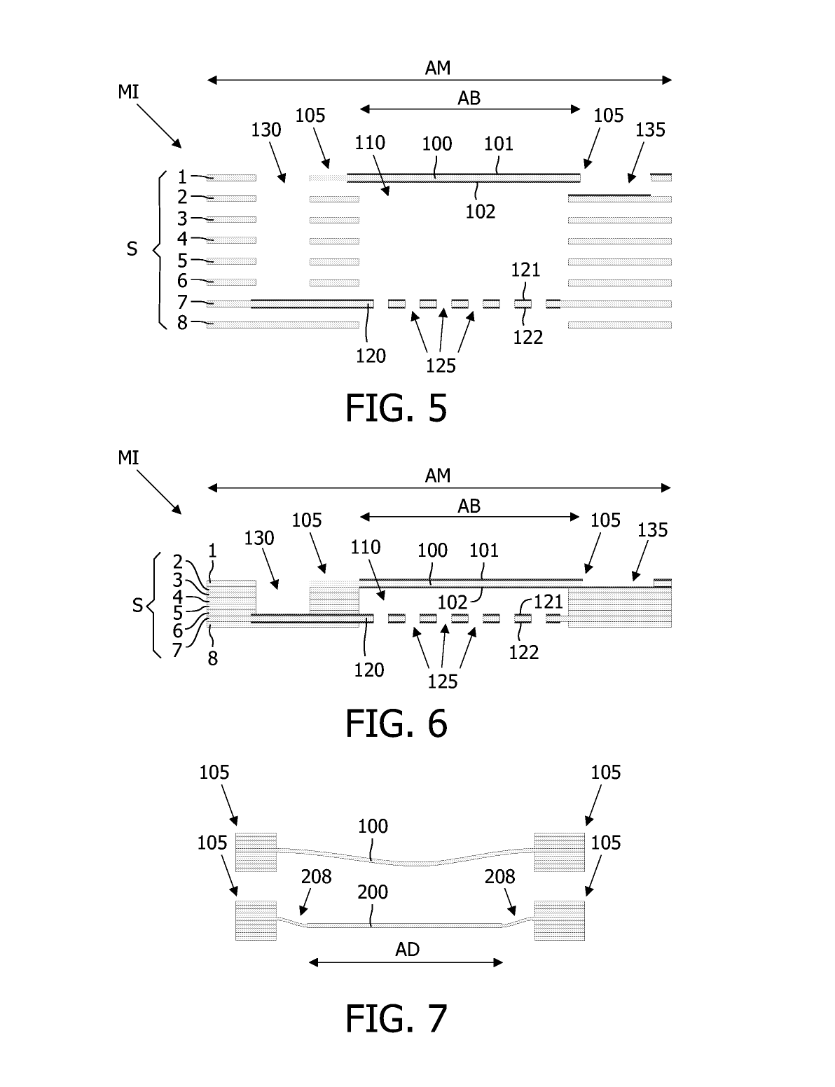

FIG. 5 shows a stack of eight foils forming an MEMS capacitor microphone structure;

FIG. 6 shows a first embodiment of the MEMS capacitor microphone according to the invention, viz. an MEMS capacitor microphone, after bonding of the foils of FIG. 5;

FIG. 7 shows a membrane of an MEMS capacitor microphone which has been thinned in certain places in accordance with one aspect of the method according to the invention;

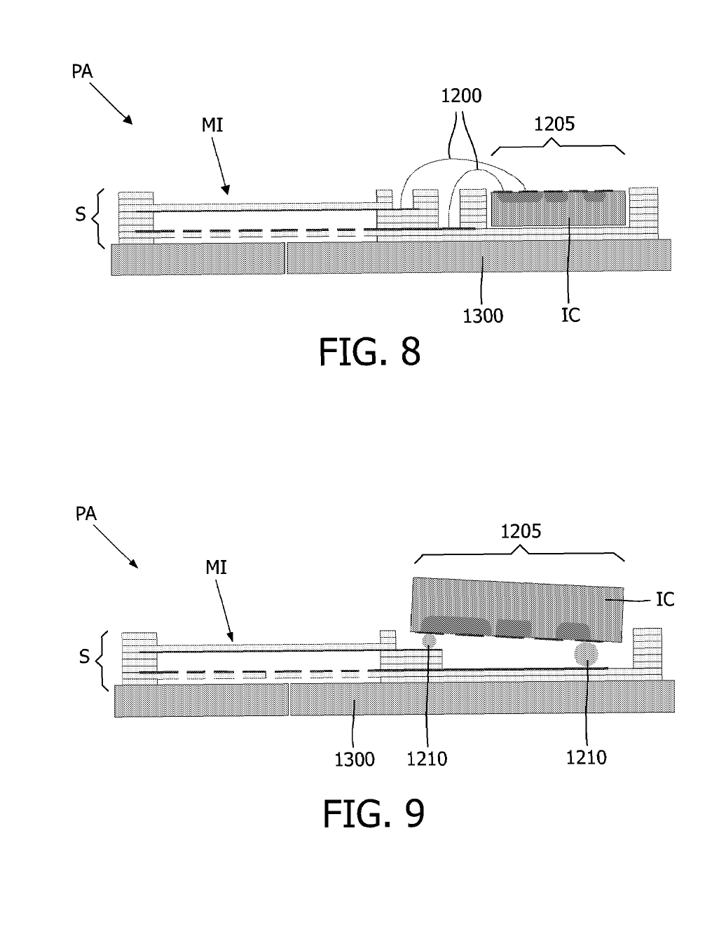

FIG. 8 shows an MEMS capacitor microphone which also functions as part of a package of an integrated circuit, in which soldering wires are used for the connections between the MEMS pressure sensor and the integrated circuit;

FIG. 9 shows an MEMS capacitor microphone which also functions as part of a package of an integrated circuit, in which flip-chip technology is used

Hereinafter a detailed description of the invention will be given. As already said before, the invention relates both to a method of manufacturing a MEMS capacitor microphone and to such a MEMS capacitor microphone itself. The method of producing the MEMS capacitor microphone comprises several substeps:

applying a conductive layer to at least one side of the foils (two sides is also possible, therefore, and is even preferable in some cases);

pre-processing the foils;

stacking the foils, thus forming the MEMS capacitor microphone;

bonding the foils; and

separating the MEMS capacitor microphone from the stack of foils.

Said pre-processing of the foils consists of a selection of the following steps:

leaving the conductive layer and the foil intact;

removing the conductive layer so as to expose the foil;

removing the conductive layer and part of the foil, so that a thinner foil remains; or

completely removing the conductive layer and the foil.

The combination of the above steps makes it possible to realize a large number of different patterns both in the conductive layer and in the foil, which enables a designer to create many different structures. Preferably, the removal of the material in the above steps is carried out by means of a laser (for example an excimer laser). A major advantage of using a laser is that said removal can take place outside a clean room, in contrast to removal by etching, for example. Several possibilities are open to a person skilled in the art in this connection. A person skilled in the art may use a wide parallel laser beam in combination with a mask, or he can scan the surface of the foil with a single laser beam and at the same time modulate the intensity of the beam. In that case a person skilled in the art can choose again between modulating either the intensity or the duty cycle of a series of brief light pulses.

FIG. 1 shows the manner in which said pre-processing by means of a collimated laser beam and a mask is carried out. The figure shows three laser beams 50, 52, 54, each having a different intensity (running up from the left to the right in this example). The mask 20 partially stops the laser beams 50, 52, 54. Present below the mask 20 is the foil 10, which is provided with a conductive layer 11a,11b on both sides in this example. It is also possible to use only one conductive layer 11a, of course. Preferably, the conductive layers 11a, 11b comprise aluminum, platinum, silver, gold, copper, indium tin oxide or magnetic materials.

In area A the mask 20 screens the foil 10, so that the low-energy beam 50 cannot reach the foil 10. The foil 10 remains unaffected. In area B the laser beam 50 does reach the foil, but the energy of the laser beam 50 is such that only the conductive layer 11a is removed (and possibly also a thin layer of the foil material, but in any case only to a negligible extent). When the energy level is further increased, a substantial part of the foil material 10 will be removed as well, so that an area C comprising a thinner foil is created. Finally, holes can be formed and the foil 10 by means of a high-energy laser beam 54. Such a hole is shown at the area D in the figure. In the foregoing, mention is made of increasing the energy level of the laser beam, which can be understood to mean that either the intensity or the duration of the laser pulse is increased. After all, the only thing that matters is that the extent to which the material is removed depends only on the amount of energy that is applied. Manipulating the duty cycle of a pulsed laser beam is easier than manipulating the light intensity of a laser beam for that matter.

After the foils 10 have been pre-processed, stacking can take place. Preferably, this is done by winding a foil onto a reel. Such an arrangement is shown in FIG. 2. The pre-processed foils 10 are in fact contained in one and the same tape in that case. When the foil material consists of Mylar, this is available inter alia in the form of a rolled-up tape having a thickness of 1 μm and a width of 2 cm. Said foil is also available with a 20 nm thick layer of aluminum present thereon (on one side or on both sides), which layer is suitable for use as the conductive layer in MEMS capacitor microphones. In the present description, however, only separate foils 10 will be discussed. In this arrangement both the front side and the rear side of the foil 10 can be pre-processed. Also in this case, this may be done by means of a laser beam, for example at positions L1, L2. The foil 10 moves in the direction X during said winding, being wound onto a reel 70, which has two flat sides in this example, in the direction of rotation R. A first laser beam at position L1 is directed at the foil that is present on the reel 70, so as to pre-process the foil 10 at the rear side 14 of the foil 10. A second laser beam at position L2 is directed at the foil that is not present on the reel 70 yet, so as to pre-process the foil 10 at the front side of the foil 10. It is not essential that the foil 10 be provided with a conductive layer on both sides 12, 14, and consequently it is not essential that the foil 10 be pre-processed on two sides 12,14, either. In some applications it may be useful, however, as will become apparent in the discussion of some of the embodiments of the MEMS capacitor microphone hereinafter.

A major advantage of winding a foil 10 onto a reel 70 is that this makes it much easier to align the foils 10. The stacking of preprocessed foils 10 (which may or may not be done by winding the foils onto a reel 70) makes it possible to create spaces and membranes. Elements of this kind are usually required in MEMS capacitor microphones.

After the foils 10 have been stacked, they can be bonded together, using an elevated pressure and an elevated temperature. When foils 10 are stacked by being wound onto a reel 70, said bonding can simply take place while the foils 10 are being wound onto the reel. In fact there are three possibilities when bonding a stack of foils:

the foil material of one foil makes direct contact with the foil material of the other foil, resulting in a strong bond;

the foil material of one foil makes direct contact with the conductive layer of the other foil, resulting in a weak bond;

the conductive layer of one foil makes direct contact with the conductive layer of the other foil, in which case a bond is not obtained.

If no pressure is exerted, the foils 10 will not bond together. This effect can be utilized for making valves. In particular when of foil 10 is adjacent to a space, it will not experience any pressure because of the flexibility of the foils. In fact the foil 10 will continue to be freely suspended. This aspect will come up again in the discussion of the MEMS capacitor microphone according to the invention hereinafter.

When it is nevertheless desirable that foils adjacent to a space be bonded, this can be achieved by using an elevated pressure in said space, for example. Said pressure may be a gas pressure but also a liquid pressure.

FIG. 3 is a schematic representation of an embodiment of a part of a possible arrangement for carrying out the method. FIG. 4 shows a photograph of an actual arrangement for carrying out the method. In the arrangement as shown, the foil 10 is unwound from a reel 80 and at the same time wound onto the aforesaid reel 70 via auxiliary rollers 90. The figure furthermore shows the possible positions of the laser beams L1, L2.

FIG. 5 and FIG. 6 show a first embodiment of the MEMS capacitor microphone according to the invention. Both figures illustrate an MEMS capacitor microphone MI, which is built up of a stack S of preprocessed foils. In FIG. 5, the MEMS capacitor microphone MI is shown in expanded form prior to the bonding of the foils. In FIG. 6 the foils are bonded together. The foil stack S may be placed on the substrate so as to make the whole more manageable. The MEMS capacitor microphone MI comprises a movable membrane 100 adjacent to a space 110, which is anchored in several areas 105. In the sectional views of the figure, said areas appear to be separated, but preferably said area 105 completely surrounds the space 110.

The membrane is provided with a conductive layer on both sides 101,102. In fact only one conductive layer is needed on one side (in this example the bottom side 102) for forming an electrode in the membrane 100, but the advantage of using a second conductive layer on the other side 101 is that warping of the membrane 100 will occur less easily. Present within the space, spaced from the membrane 100 by some distance, is a backplate 120, which is likewise provided with a conductive layer on both sides 121,122. In fact only one conductive layer is needed on one side (in this example the upper side 121) for forming an electrode in the backplate 120, but also in this case the advantage of using a second conductive layer on the other side 122 is that warping of the backplate 120 will occur less easily. The electrodes of the membrane 100 and the backplate 120 jointly form a capacitor. The spacing between the capacitor plates amounts to five foils in this example. When foils having a thickness of 1 μm are used, the spacing will amount to 5 μm. If the MEMS capacitor microphone MI has a surface area AM of 2×2 mm², the surface area AB of the membrane 100 may come close to said value (the dimensions are not to scale in the drawing). In other words, the surface area in the MEMS capacitor microphone MI according to the invention can be utilized more efficiently than with the known MEMS capacitor microphone, such as the MEMS microphone that is known from the publication by Udo Klein, Matthias Müllenborn and Priming Romback “The advent of silicon microphones in high-volume applications”, MSTnews 02/1, pp. 40-41. When the Mylar tape having a width of 2 cm is used, it is possible to produce ten MEMS microphones alongside each other in an almost infinite number of rows (determined only by the length of tape on the reel).

The backplate 120 is preferably provided with openings 125 for releasing differences in air pressure that arise in the space 110 during vibration of the membrane 100 induced by sound waves. The operation of the MEMS microphone is as follows. Sound waves set the membrane 100 in motion (the membrane will start to oscillate). As a result, the spacing between the membrane 100 and the backplate 120 will start to oscillate as well, which in turn leads to oscillation of the capacitance of the capacitor (formed by the conductive layers on the membrane 100 and the backplate 120). These capacitance changes can be electrically measured and are at the same time a measure of the sound waves on the membrane 100.

The MEMS capacitor microphone MI is provided with contact holes 130, 135 that function to provide access to the capacitor plates (electrodes) of the membrane 100 and the backplate 120. The upper electrode on the membrane 100 is positioned partially on foil 1 and partially on foil 2. In this way the electrode will become accessible from the upper side via the contact hole 135.

In the example of FIG. 5 and FIG. 6, the MEMS capacitor microphone MI comprises a stack S of eight foils 1,2,3,4,5,6,7,8. A different number of foils is also possible, however. This depends in particular on the desired vertical dimensions and spacing values of the microphone.

In case the tensile stress of the membrane 100 is not sufficient, as a result of which the deflection profile of the membrane is not optimal, the designer may elect to make the membrane 100 thinner at the edges. This is shown in FIG. 7. Both membranes 100 are anchored in areas 105. The upper membrane 100 in the figure does not comprise any thinned areas and deflects most strongly in the center on account of the sound pressure. The lower membrane 200 in the figure, on the other hand, does comprise thinned areas 208 at the edge, as a result of which the membrane 200 exhibits the same extent of the deflection over a relatively large area AD. The consequence of this aspect is that a larger electrical signal on the capacitor (made up of the conductive layers on the membrane 100 and the backplate 120) of the MEMS capacitor microphone MI can be measured with the same sound pressure. The forming of such thinned areas 208, using the method according to the invention, is fairly simple for that matter (partial removal of the foil, for example by means of a laser), whereas this is very difficult in silicon technology.

FIG. 8 and FIG. 9 show another important advantage of the MEMS capacitor microphones according to the invention. The fact is that it is also possible to manufacture the MEMS capacitor microphone according to the invention in such a manner that it also forms part of the package PA of an integrated circuit IC (which may or may not be connected to the MEMS capacitor microphone). FIG. 8 and FIG. 9 show an MEMS capacitor microphone MI having an opening 1205 in the foil stack S. Present in the opening 1205 is the integrated circuit IC. In this example, the integrated circuit IC is connected to electrodes of the MEMS capacitor microphone MI. The connections are formed by metal wires 1200 (e.g. gold or copper whilst) in FIG. 8 and by solder balls in FIG. 9. The second possibility is also referred to as flip-chip technology. Both in FIG. 8 and in FIG. 9 the MEMS capacitor microphone MI is provided on a substrate 1300. However, it is also possible not to use a substrate 1300 but, for example, a much thicker foil stack S.

From the examples in the present disclosure it can be concluded that the invention can be used for manufacturing MEMS capacitor microphones in an inexpensive manner. The products obtained by using the present invention can be used in consumer electronics in which cooperation between electronic devices and the environment is necessary.

As regards the selection of the foil material, many materials may be used, for example polyvinyl chloride (PVC), polyimide (PI), Poly(ethylene terephthalate) (PET), poly(ethylene 2,6-naphthalate) (PEN), polystyrene (PS), polymethyl methacrylate (PMMA), polypropylene, polyethene, polyurethane (PU), cellophane, polyester, parilene. In fact it amounts to this that any material that meets a number of criteria may be used. Attention should be paid that:

the thickness of the foil determines the vertical resolution;

the foil, as the basic material, must be manageable, preferably supplied on a roll;

the foil is capable of being metallized;

the metallized foil is capable of being preprocessed, preferably by means of a laser;

the foil can be bonded after stacking, preferably by using heat and pressure;

the material can be melted at “low” temperatures (<300 degrees); and

the foil stack, after stacking and bonding, possesses the properties that are required for the MEMS capacitor microphone.

An important note in this connection is that the bonding of the foils preferably takes place at a temperature just below the melting point of the foil material. For example, if polyethylene terephthalate (PET) is used as the foil material (having a melting point of 255° C.), a temperature of, for example, 220° C. will be used.

More in particular, the foil material must be selected on the basis of the properties required for the application in question, viz.: temperature stability, shape stability, pressure resistance, optical and chemical properties.

Finally, inorganic, insulating foils may be used, such as mica.

All the figures in the present description are merely schematic representations, which are moreover not drawn to scale. They are intended by way of illustration of the embodiments aimed at by the invention and to provide technical background. In reality, the shapes of boundary faces may differ from those of the boundary faces that are shown in the figures. In those places where the word “a(n)” is used, a number larger than one may be used, of course. It stands to reason that those skilled in the art will be able to devise new embodiments of the invention. Such new embodiments all fall within the scope of the claims, however.

Possible variations on the method according to the invention are the winding up of two foils at the same time. The foils may or may not come from two different rolls, for example. Furthermore, the foils may already be bonded. In addition, the foils may already be patterned. According to another variant, the foils do not have the same thickness. Furthermore, more than two foils may be wound up.

In the present description, the example of winding up a foil is extensively illustrated. It is also possible to stack separate foils, of course. In that situation it is also possible to stack foils that do not have the same thickness.

In addition, all the embodiments of the MEMS capacitor microphone that have been described herein may comprise a number of foils different from the number mentioned herein. This depends in part on the designer's requirements.

1. A method of manufacturing a Micro-Electro-Mechanical System (MEMS) capacitor microphone provided with a space, which method comprises the following steps:
providing a set of at least two electrically insulating flexible foils, wherein a conductive layer is present on at least one side of at least one foil, and wherein said conductive layer is suitable for use as an electrode or a conductor;
patterning the conductive layer so as to form an electrode or a conductor;
patterning at least one foil, in such a manner that an opening is formed, which opening forms the space of the MEMS capacitor microphone;
stacking the set of foils, thus forming the MEMS capacitor microphone; and
joining the foils together, with the foils being bonded together at those positions where, when two adjacent foils are in contact with each other, at least one conductive layer between the foil material of two adjacent foils has been removed.

2. A method as claimed in claim 1, characterized in that a set of foils is provided, with the individual foils comprise the same type of foil material.

3. A method as claimed in claim 1, characterized in that a set of foils is provided, with the individual foils having substantially the same thickness.

4. A method as claimed in claim 1, characterized in that at least three electrically insulating flexible foils are provided.

5. A method as claimed in claim 1 comprising the additional steps of:
patterning a first flexible foil in a way that a membrane is formed covering one side of at least one opening;
patterning a second flexible foil in a way that there is at least one hole in the second flexible foil being in contact with the opening.

6. A method as claimed in claim 1, characterized in that said patterning is carried out by means of a laser, whether or not in combination with a masks.

7. A method as claimed in claim 1, characterized in that said stacking of the foils takes place by winding at least one foil onto a first reel.

8. A method as claimed in claim 7, characterized in that the method is carried out in a process in which the foil is unwound from a second reel or roll upon being wound onto the first reel.

9. A method as claimed in claim 1, characterized in that said joining of the foils is carried out by exerting a pressure on the stacked foils at an elevated temperature, with the pressure being exerted in a direction perpendicular to the foils.

10. A method as claimed in claim 9, characterized in that the required pressure on the foils adjacent to the space in the structure is obtained through the application of an elevated pressure in said space.

11. A method as claimed in claim 1, characterized in that the MEMS capacitor microphone is individualized from the stack after fusion of the foils has taken place.

12. A method as claimed in claim 1, characterized in that the foil material is selected from the group consisting of polyphenyl sulphide and polyethylene terephthalate.

13. A method as claimed in claim 1, characterized in that the foil that is used has a thickness between 1 μm and 5 μm.

14. Micro-Electro-Mechanical System (MEMS) capacitor microphone comprising a stacked set of at least two electrically insulating flexible foils, wherein a patterned conductive layer is present on at least one side of at least one foil, and wherein said conductive layer is suitable for use as an electrode or a conductor; at least one foil is patterned in such a manner that an opening is formed, which opening forms the space of the MEMS capacitor microphone; and the foils are bonded together at those positions where, when two adjacent foils are in contact with each other, at least one conductive layer between the foil material of two adjacent foils has been removed.

15. A MEMS capacitor microphone as claimed in claim 14, characterized in that the set of foils comprises at least three foils, with a space being present in the microsystem, which space is provided on a first side thereof with a first foil arranged as a membrane for absorbing sound waves, and which space is provided on a second side thereof with a second foil arranged as a backplate, which second foil comprises an opening for the passage of pressure waves to a free space, which space has a thickness, measured in a direction perpendicular to the foils, of at least one foil, and in that the microsystem is further characterized in that the membrane and the backplate are also provided with a conductive layer, which layers lead to areas for electrically connecting the microsystem.

16. A MEMS capacitor microphone as claimed in claim 14 comprising an opening in the stack of foils so as to provide access from one side of the MEMS capacitor microphone to a conductive layer that is connected to an electrode of the MEMS capacitor microphone.

17. A stack of electrically insulating flexible foils comprising the MEMS capacitor microphone as claimed in claim 14.

18. An electronic device comprising the MEMS capacitor microphone as claimed in claim 14.

19. An electronic device comprising the stack of electrically insulating flexible foils comprising the MEMS capacitor microphone as claimed in claim 17.

20. An electronic device as claimed in claim 18, characterized in that said electronic device furthermore comprises an integrated circuit for reading or driving a signal from the MEMS capacitor microphone.

21. An electronic device as claimed in claim 20, characterized in that the MEMS capacitor microphone is provided with a recess, in which the integrated circuit is accommodated, so that the MEMS capacitor microphone in fact forms part of the package of the integrated circuit, which integrated circuit is connected to the MEMS capacitor microphone.

22. Use of the electronic device as claimed in claim 19, characterized in that the MEMS capacitor microphone delivers a voltage X on electrodes for recording sound and wherein the voltage X is read by the integrated circuit.
